(19) United States
(12) Patent Application Publication
(10) Pub. No.: US 2023/0256838 A1
(43) Pub. Date: Aug. 17, 2023

(54) METHOD FOR PERFORMING AN ELECTRICAL CHARGING PROCESS

(71) Applicant: AUDI AG, Ingolstadt (DE)

(72) Inventors: Jürgen HORVATH, Pfakofen (DE); Franz LANKES, Ingolstadt (DE)

(21) Appl. No.: 18/169,029

(22) Filed: Feb. 14, 2023

(30) Foreign Application Priority Data
Feb. 15, 2022 (DE) 102022103472.0

(51) Int. Cl. B60L 53/10; B62D 15/02; B60L 53/30

(52) U.S. Cl. CPC B60L 53/10; B62D 15/0285; B60L 53/305; B60L 2240/62; B60L 2250/00

(57) ABSTRACT

A method for performing an electrical charging process for a vehicle in a charging park, the vehicle having at least one charging interface, while the charging park has at least one electrical charging station with at least one charging interface, comprises situating the vehicle in an actual physical location on the grounds of the charging park, and checking to see whether the actual physical location does or does not fulfill a physical access requirement to the at least one charging interface of the at least one charging station, and in the event that the access requirement is not fulfilled the driver is asked to place the vehicle in a nominal physical location, and in the event that the physical access requirement is fulfilled the vehicle is moved automatically from the actual physical location to a selected charging station among the at least one charging station and automatically arranged in a charging position.

### BACKGROUND

### Technical Field

Embodiments of the invention relate to a method for performing an electrical charging process for a vehicle and a system for carrying out an electrical charging process for a vehicle.

### Description of the Related Art

In order to charge the drive battery of a vehicle, it is necessary to position the vehicle at a sufficiently short distance from a charging station, in order to connect the drive battery to the charging station.

Document CN 212827962 U describes a control device for the charging of an electrical vehicle.

A system for steering a vehicle is known from document CN 102508489 A.

A method for automatic finding of an optimal wireless charging position is described in the document KR 102120255 B1.

Against this background, one problem was to support a driver of a vehicle when performing a charging process.

### BRIEF SUMMARY

Some embodiments include carrying out an electrical charging process, such as an at least semiautomatic or an automatic charging process, for an electrical drive battery as the energy accumulator of an electric vehicle in a charging park. The vehicle here comprises at least one charging interface, which is usually accessible from the outside. The charging park comprises at least one electrical charging station, such as a so-called charging point. It is proposed that the vehicle, usually after being driven or having been driven previously to the charging park, is situated or positioned in a current actual physical location on the grounds of the charging park, where the at least one charging station is situated. Starting from this, the actual location is usually detected by at least one sensor and it is determined whether the actual physical location in which the vehicle is currently situated does or does not fulfill a physical access requirement to the at least one charging interface of the at least one charging station. If the physical access requirement is not fulfilled by this actual location, the driver is asked to position the vehicle in a nominal physical location among at least one nominal physical location, which is proposed to the driver for this purpose. In one embodiment, it is possible to propose to the driver only one nominal location or multiple nominal locations for a selected charging station. If, alternatively, the physical access requirement is fulfilled by the current actual location, the vehicle is moved automatically from the current actual physical location to a selected charging station among the at least one charging station of the charging park and automatically placed in a charging position coordinated with the selected charging station.

Once the vehicle has been automatically arranged in the charging position, the at least one charging interface of the vehicle is automatically or manually connected to the at least one charging interface of the selected charging station and the charging process is carried out, electrical energy being transferred from the charging station to the vehicle or its drive battery, whereupon it becomes charged.

In the method, it is possible in one embodiment to propose to the driver only one nominal location or multiple nominal locations for a selected charging station. If the current and/or a respective actual location of the vehicle fulfills the physical access requirement, the vehicle will be moved automatically by at least one computing unit under machine control to the charging position and arranged, i.e., positioned or oriented, in this position. It is possible for the vehicle to be machine-controlled by its own computing unit and at least one computing unit of the charging park, for example at least one computing unit of the at least one charging station, it being possible for these two computing units to exchange signals with control commands between each other by a communication system for the automatic moving of the vehicle. It is possible for the vehicle to be at least partially or entirely automatically remote controlled by the at least one computing unit of the charging park. Alternatively or additionally, the vehicle will be at least partially or entirely automatically controlled by its computing unit and will move at least partially automatically, such as semi automatically or semi autonomously, or entirely automatically or autonomously.

If the actual physical location of the vehicle does not fulfill the provided physical access requirement and the driver is asked to position the vehicle in the at least one proposed nominal location, the vehicle will be moved by the driver, under driver control, from the current actual physical location to a new updated actual physical location, usually being controlled, such as remote controlled, and/or driven. Once the vehicle is positioned in a correspondingly resulting updated actual physical location, a check is done to see whether or not this resulting or new updated actual physical location corresponds to the at least one proposed nominal location, and whether or not the physical access requirement is fulfilled. In order to change the actual location, the vehicle and/or its movement will be controlled by the driver. During this process, in one possible embodiment it is conceivable for the driver to be informed as soon as the particular current actual location which is reached fulfills the access requirement provided for this.

In one embodiment of the method, it is proposed that each time one of the proposed locations involves respectively a physical position or a physical site and respectively a physical orientation and/or is dependent thereon. The respective actual physical location as the location of the vehicle is dependent on the one hand on an actual physical position as the position or site of the vehicle on the grounds of the charging park and on the other hand on a current actual physical orientation, and thus a respective orientation of this location of the vehicle within the charging park, which is detected by the at least one sensor. Alternatively or additionally, the at least one nominal physical location which may be required as the location of the vehicle is dependent on the one hand on at least one nominal physical position, i.e., at least one corresponding site of the vehicle on the grounds of the charging park, and on the other hand on at least one nominal physical orientation and thus a respective orientation of this location which the vehicle should occupy within the charging park, this at least one nominal location being proposed and/or dictated to the driver. A particular orientation of the vehicle, i.e., the actual orientation or nominal orientation, is usually described and/or defined in dependence on a forward travel direction of the vehicle.

The charging position as the location of the vehicle is likewise usually defined by a charging position for the vehicle and a charging orientation and thus an orientation of this location of the vehicle, which is suitable and/or provided for carrying out the charging process. The charging position is physically coordinated with the selected charging station, usually being situated next to it, and the at least one charging interface of the vehicle and the at least one charging interface of the selected charging station have at most a permissible and/or provided distance from each other or relative to each other when the vehicle is located in the charging position. In the method, the vehicle, when it is moved automatically to the selected charging station, starting from the actual location which fulfills the access requirement, is moved both to the charging position and positioned here and also moved to the charging orientation and positioned here, it being possible for the vehicle to maneuver automatically, for example.

In one embodiment of the method, it is proposed that the respective actual location of the vehicle is the location in which the vehicle was placed by the driver under driver control and/or machine control and where it is currently situated. The at least one nominal location is the location in which the vehicle is to be or should be placed by the driver in order to be taken automatically to the charging position, starting from that location. If an obstacle or barrier stands in the way of a direct path from an actual location of the vehicle to the nominal location, the vehicle can only be placed in and/or moved to the nominal position by the driver under driver control, since the vehicle cannot be placed in this location automatically, i.e., under machine control. A possible obstacle or a possible barrier is usually an object on the grounds which the vehicle cannot automatically drive around. The at least one obstacle can be situated in fixed location on the grounds or be moving on the grounds. The charging position is that location of the vehicle which allows the charging process to be carried out when the vehicle has been placed in this position automatically or under machine control, starting from an actual location. If the driver is able to place the vehicle in an actual location corresponding to the charging position, the charging process can be carried out without the vehicle having to be moved further by the driver, under control or automatically. This is also the case when the driver is asked to place the vehicle in the at least one nominal location, starting from a respective actual location, and the vehicle may have to be placed in a prescribed charging position so that the charging process can be carried out, without further movement of the vehicle being necessary, automatic or controlled by the driver. If the driver is successful in placing the vehicle in an actual location, usually freely accessible or free of obstacles, which at the same time corresponds to the charging position, a check will likewise and/or nevertheless be performed for it to see whether or not it fulfills the access requirement. But since it fulfills this, the driver can be informed that no further movement of the vehicle, either under machine control or under driver control, is necessary in order to carry out the charging process.

The at least one charging interface of the vehicle is arranged at least in one interface position on an outer wall of the vehicle, for example on the side or on a side wall at left and/or right, on a rear and/or at the nose of the vehicle. Multiple charging interfaces can be arranged on multiple sides of the vehicle in front, at the rear, or at the side. The at least one charging interface of the vehicle or the at least one charging station is designed as a charging socket or a charging plug. The at least one interface position of the at least one charging interface may vary greatly for different vehicles, specific to the vehicle type.

It is proposed that the respective actual physical location, especially the actual physical orientation of the vehicle is dependent on the at least one interface position of the at least one charging interface of the vehicle. Alternatively or additionally, the at least one nominal physical location, especially the at least one nominal physical orientation of the vehicle is dependent on the at least one interface position of the at least one charging interface of the vehicle and/or at least one interface position of the at least one charging interface of the at least one charging station. Usually, the physical orientation, i.e., the actual orientation and/or nominal orientation of the vehicle in the respective position, i.e., the actual position or nominal position, and the interface position of the at least one charging interface on the outer wall of the vehicle are taken into account.

It is proposed that the vehicle, depending on the situation, will be moved into the particular actual location, also dependent on the at least one proposed nominal location, under machine control automatically, semi automatically, and/or under driver control by the driver or through the driver, for example steered by the driver or manually, directly using the steering wheel of the vehicle or indirectly using a remote control of a terminal device. If and/or once the vehicle is situated on the grounds in an actual location which fulfills the access requirement and furthermore corresponds to the at least one nominal location, it is moved from this location automatically, i.e., controlled by the at least one computing unit, for example remote controlled, and/or self-acting, and placed in the charging position, without requiring any control and/or intervention by the driver for this.

Furthermore, it is proposed that the nominal location and/or the charging position is dictated and/or provided in dependence on at least one power transmission element. The at least one power transmission element is configured, e.g., as a charging cable having a specific length, in order to connect the at least one charging interface of the vehicle to the at least one charging interface of the at least one charging station and to exchange electrical energy between the at least one charging interface of the vehicle and the at least one charging interface of the at least one charging station, the drive battery of the vehicle being usually charged and supplied with electrical energy across this power transmission element.

It is also possible for the at least one charging interface of the selected charging station to be configured as a sender, such as an induction source, and the at least one charging interface of the vehicle to be configured as a receiver for an inductive cable-free charging process, wherein the at least one charging interface of the selected charging station and the at least one charging interface of the vehicle have at most the prescribed distance from each other when situated in the charging position.

Furthermore, the physical access requirement provided and/or to be provided for a respective actual location of the vehicle is likewise dependent on the at least one power transmission element and respective positions of the charging interfaces on the vehicle and the at least one charging station. If such a power transmission element is configured, e.g., as a charging cable, it will have the specific maximum length. If the vehicle is arranged in the charging position, the permissible prescribed distance between the at least one charging interface of the vehicle and the at least one charging interface of the charging station is at most as large as the length of the charging cable.

If it is decided that the particular current actual location of the vehicle does not fulfill the access requirement, this means that the vehicle itself cannot automatically reach a provided charging position starting from this actual location.

As described above, a particular actual location of the vehicle is dependent on its particular actual position. However, it is also possible for the vehicle to have different actual orientations in a respective actual location, which means, among other things, that the at least one charging interface in the same actual position of the vehicle with different actual orientations has correspondingly different distances from the at least one charging interface of the selected charging station. Thus, the at least one charging interface of the vehicle in a particular charging position may be facing toward or away from the at least one charging interface of the selected charging station, the distance being greater if the at least one charging interface of the vehicle is facing away, and the distance being less if the at least one charging interface of the vehicle is facing toward the at least one charging interface of the selected charging station.

Before the vehicle is positioned on the grounds of the charging park, it is at first located in an original position outside the grounds of the charging park. Moreover, it is proposed that the performance of the charging process is initiated by the driver himself and/or automatically, if a critical state of charge is determined for the drive battery. In this case, starting from the original position of the vehicle, a charging park among multiple charging parks or a position of this charging park is determined and/or selected and the vehicle and/or its driver navigates to this charging park. Once the vehicle has reached the charging park, it is positioned in the actual location on the grounds of the charging park.

The system according to some embodiments is designed for the usually automatic performing of an electrical charging process for a vehicle in a charging park, the vehicle comprising at least one charging interface for a drive battery and the charging park comprising at least one electrical charging station with at least one charging interface. It is proposed that the vehicle is already located on the grounds of the charging park in a current actual physical location, given by the actual position and/or actual orientation of the vehicle. The system comprises as its components at least one usually optical sensor, such as a camera, at least one computing unit, and at least one output module. The at least one sensor is designed to detect, determine, and/or ascertain the actual physical location of the vehicle. The at least one computing unit is designed to verify, based on the actual physical location of the vehicle so determined, whether or not this actual physical location in which the vehicle is currently situated fulfills a physical access requirement to the at least one charging interface of the at least one charging station. If it is determined by the at least one computing unit that the access requirement is not fulfilled, the at least one output module is activated by the at least one computing unit, the at least one output module being designed to ask the driver, usually optically by text, for example, and/or acoustically, to position the vehicle in a prescribed nominal location among at least one nominal location proposed for this. If, alternatively, the at least one computing unit determines that the physical access requirement is fulfilled for the current actual location of the vehicle, the at least one computing unit is designed to move the vehicle automatically from the current actual physical location to a selected charging station among the at least one charging station, e.g., to drive and/or maneuver it, and place it automatically in a prescribed charging position.

Furthermore, the at least one charging interface of the vehicle is designed to connect to the at least one charging interface of the selected charging station and to carry out the charging process. The charging interfaces of the vehicle and the selected charging station are manually connected across the power transmission element, usually by the driver. However, it is also conceivable for the charging interfaces to be connected automatically, usually through a robot of the charging park and/or the system.

It is possible to implement one embodiment of the method described herein with one embodiment of the system described herein, usually to the full extent, wherein the method or its sequence is monitored and thus controlled and/or regulated by the at least one computing unit. With the system, when carrying out the method, it is possible to arrange the vehicle automatically in the prescribed charging position and to drive up automatically to this charging position or the selected charging station.

The system comprises at least one radio-based or wireless communication system having at least two antennas for exchanging information between at least two components, which are used in one embodiment of the method. Such components are the vehicle, at least one terminal device of the driver or for the driver, at least one charging station and/or the charging park itself. It is also possible for such information to be exchanged in order to carry out the method alternatively or additionally between two computing units of the system, being associated with two of the mentioned components and/or arranged in them, it being possible for at least one of the at least two computing units to be configured as the at least one computing unit of the proposed system.

It is possible for one computing unit to be integrated or arranged in the vehicle and in one possible embodiment it is also designed to control at least partly or fully automatically a movement of the vehicle, i.e., usually to guide or steer it. It is also possible for one computing unit to be arranged in the terminal device of the driver, it being possible for the driver to initiate a performance of the method and/or to control the vehicle, usually by remote control, through the terminal device and/or the computing unit. Moreover, it is possible for at least one computing unit to be coordinated with the charging park and/or at least one charging station and/or to be arranged in it and designed to control the vehicle, usually by remote control.

It is also proposed in one embodiment that this input device of the driver comprises the at least one optical and/or acoustic output module, such as a microphone and/or a display field. The input device of the driver is configured either as a portable mobile input device, such as a smartphone or tablet, for communication and data processing. It is also possible for such an output module and/or terminal device to be permanently installed in the vehicle. For the movement of the vehicle to a particular actual location, it can be remote controlled and monitored by the driver with the terminal device outside or inside the vehicle.

Through the communication system, said components or their computing units can communicate with each other when carrying out the method and exchange the necessary information for this. Such information involves, for example, information as to whether or not a particular actual location fulfills the proposed access requirement for this. Moreover, it is possible to propose the at least one nominal location as the information from the at least one charging station and/or the charging park to the input device of the driver. For the automatic movement of the vehicle from an actual location which fulfills the access requirement to the charging position, it is possible for the charging park and/or the at least one charging station on the one hand and the vehicle on the other hand, usually their computing units, to communicate directly with each other, the vehicle being moved automatically on the basis of information exchanged during such a direct communication.

With the communication system or a corresponding supported communication link it is possible to exchange information for a service or a servicing in order to carry out the charging process between the at least one charging station and/or the charging park on the one hand and the vehicle and/or the terminal device on the other hand. A communication link provided with the communication system between respective components is usually provided wirelessly, e.g., through the internet, a central communication site as the connection site, such as a central server, associated with at least one charging park, or directly between the at least one charging station and the vehicle and/or the terminal device, such as via the internet, Bluetooth or a near field communication (NFC). Usually a communication or a communication link is provided for security reasons, especially IT security reasons, between the central communication site and the vehicle and/or the terminal device. If a connection to the central communication site or a corresponding server should fail, a direct communication or communication link is used between the at least one charging station and/or the charging park and the vehicle and/or the output module.

Before the vehicle is arranged on the grounds in an actual location, it is possible in one embodiment of the method with one embodiment of the system to select, to ascertain, to identify and/or to locate in advance the charging park as one option for carrying out the charging process, usually among multiple charging parks. In a so-called offline instance it is provided that a location service, usually a navigation and/or location system (GPS) is used in concert with a digital offline map, in which different charging parks are stored as charging options. In an online instance, the location service, such as the navigation and/or location system, is also used in concert with a digital online map, in which at least one charging park is stored, i.e., one charging park or multiple charging parks. It is further possible to provide such an online map to the vehicle and/or to the terminal device via the central communication site, such as the server. It is also possible, in order to identify the charging possibility, for the vehicle and/or the terminal device to communicate with the at least one charging station and/or the charging park by direct wireless information and/or data processing. In this case, a location service is unnecessary, since the vehicle and the at least one charging station in one possible embodiment are already at a distance from each other which enables the direct communication, if the direct wireless data link is or can be established between the vehicle and/or the terminal device and the at least one charging station.

Various informational queries can be carried out with the described communication system. It is possible, among other things, for the vehicle and/or the terminal device to request multiple items of information from the charging park through the central server or alternatively directly from the at least one charging station and/or from the charging park. This is also possible before the vehicle is positioned on the grounds of the charging park or is at first approaching the charging park, when it is driving to or has driven to it. It is possible to interrogate a number of charging stations and/or charging parks situated in the vicinity of the vehicle. Moreover, it is possible to request the occupancy status of the at least one charging station, such as a charging point of the charging park. It can be ascertained how many charging stations are either free or occupied. A time for the next availability of at least one charging station can also be requested, which may occur for example when all the charging stations are still occupied at the moment. In response to such a query, a time point or a time interval, such as ten minutes, when at least one charging station will be free can be sent to the vehicle and/or the terminal device from the charging park and/or the at least one charging station. It is also possible to ask about the length of the charging cable as the power transmission element. It is possible to use a charging cable of the charging park or the vehicle as the power transmission element. Furthermore, it is proposed that the charging park and/or the at least one charging station on the one hand and the vehicle on the other hand mutually exchange information about the length of the charging cable to be used, and to determine on this basis the physical access requirement, the nominal location, and/or the charging position.

If the charging cable is arranged in the vehicle, it is possible for example to provide information about its length and the configuration of charging interfaces at the ends of the charging cable, i.e., at least one charging socket and/or one charging plug, from the vehicle to the at least one charging station or the charging park. This is possible manually by entry in the terminal device, e.g., an infotainment system of the vehicle, by saving such information through a factory programming, through the terminal device configured as a smartphone, for example, and/or through a near field communication (NFC). The charging cable can be arranged in a luggage compartment of the vehicle, configured or designated as a front trunk or frunk. It is also possible for the at least one charging point to request the information about the charging cable of the vehicle from the latter.

It is also possible to ask about the plug type and/or the socket type of the at least one charging interface of the at least one charging station. Furthermore, the available charging capacity of the at least one charging station in kilowatts can be queried. In a further embodiment, it is possible to ask about an authorization option and/or a payment option for the electrical energy transferred during the charging process. For a usually autonomous vehicle it is possible to ask about positions of charging stations on the grounds. Alternatively or additionally, it is also possible to request a detailed map of the charging park, in which the positions of charging stations, such as charging points, are indicated.

Furthermore, it is possible to monitor a so-called charging valet service or a payment service for the charging process through the communication link between the vehicle and/or the terminal device on the one hand and the at least one charging interface or the charging park on the other hand.

With the method and the system it is possible for the selected charging station to be directly and automatically positioned by the electrically operated vehicle, usually an electrically operated motor vehicle, such as an electric vehicle or a hybrid vehicle, in the prescribed charging position at, near and/or alongside a selected charging station, when it is moved automatically into the charging position.

The performing of the charging process is initiated, e.g., by the terminal device. When the charging process is concluded, it is possible for the vehicle to move away from the charging position, again automatically, and to then exit from the charging park. The method takes account of knowledge about the vehicle, i.e., the at least one interface position of the at least one charging interface, the design of charging accessories, such as the charging cable as the power transmission element of the vehicle or the charging park. Moreover, knowledge about the charging park is taken into account, i.e., its floor plan and the position of charging stations, which may be occupied or free. Furthermore, knowledge as to the charging capacity and an authorization possibility of the at least one charging station is used.

Once the driver with the vehicle has reached the actual location on the grounds of the charging park that fulfills the access requirement, he can leave the vehicle, since it is now possible for the vehicle to drive up automatically to a selected free charging station suitable for the charging process and is automatically placed in the charging position assigned to it, since a path between the actual location and the charging position enables a corresponding automatic movement of the vehicle. It is also possible for the vehicle to drive autonomously through narrow passages on the grounds along the way and/or to automatically drive past obstacles.

Of course, the features mentioned above and those yet to be explained below can be used not only in the particular indicated combination, but also in other combinations or standing alone.

### BRIEF DESCRIPTION OF THE SEVERAL VIEWS OF THE DRAWINGS

Embodiments are presented schematically with the aid of the drawing and shall be described schematically and at length with reference to the drawing.

FIG. 1 shows in schematic representation an example of a charging park and one embodiment of a system for carrying out an embodiment of a method.

### DETAILED DESCRIPTION

The figures are described in connection with each other. The same reference numbers are associated with the same components.

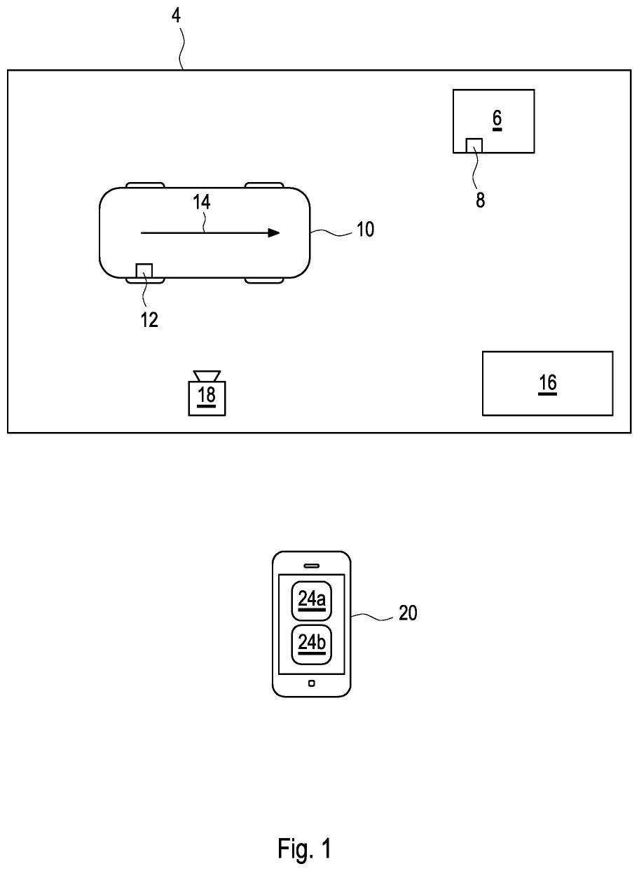

Grounds 4 are shown schematically from the example of the charging park in FIG. 1, on which multiple charging stations 6 are arranged, configured and/or designated here as charging points, of which only one is shown here, having a charging interface 8. Furthermore, the charging park comprises a computing unit 16 and multiple sensors 18, here being cameras, for optical registration of the grounds 4 of the charging park, only one such sensor 18 being shown here.

The computing unit 16 and the sensors 18 are also configured as components of the embodiment of the system described herein. Further components of the embodiment of the system described herein are a computing unit, not further shown here, of a vehicle 10 which is arranged here on the grounds 4, an output module configured as a display field or display, and a computing unit, not further represented, of a terminal device 20 of a driver of the vehicle 10. It is proposed that the output module configured as a display field is touch sensitive, there being two input fields 24a, 24b manually operated by the driver on the display field of the output module.

With the embodiment of the method described herein, an electrical charging process is carried out for a drive battery of the vehicle 10, not further shown. This drive battery of the vehicle comprises at least one battery module and thus in one embodiment also multiple battery modules as electrical energy accumulator for at least one electric machine to drive the vehicle. For this vehicle 10, a forward travel direction 14 is indicated by an arrow in FIG. 1. On an outer wall of the vehicle 10, being a right side outer wall, given the forward travel direction 14, there is arranged a charging interface 12 for the drive battery.

In the embodiment of the method, it is first of all proposed that the vehicle 10 is situated outside the grounds 4 and thus outside the charging park. As soon as an electrical charging of the drive battery is needed on account of a low state of charge, a performing of the charging process is initiated either automatically by the computing unit of the vehicle 10 or by the driver through an entry on his terminal device 20. In the embodiment of the method it is assumed that multiple charging parks exist, being distributed in space. As soon as the performing of the charging process is initiated, a request to carry out the charging process is sent by the computing unit of the vehicle 10 or by the terminal device 20 to a computing unit not otherwise shown, such as a server, for all the charging parks.

Taking into account an original position of the vehicle 10 outside the grounds 4, the computing unit selects for all the charging parks a charging park having the shortest distance from the original position of the vehicle 10 and/or one which can be reached in the shortest span of time. Furthermore, the vehicle 10 and/or its driver is navigated to the grounds 4 of the selected charging park. Moreover, the vehicle 10 is arranged on the grounds 4 at an actual location, shown here, resulting from an actual physical position of the vehicle 10 on the grounds 4 and an actual physical orientation of the vehicle 10 inside the charging park, this actual orientation being given here by the forward travel direction 14 and an interface position of the charging interface 12 on the outer wall of the vehicle 10. Once the vehicle 10 comes to a halt and/or is halted at the actual location, the driver is told through the output module of the terminal device 20, in one optional embodiment, whether or not a charging valet (CHAVA) service or a payment service can be used by him and whether an additional action is necessary by him before performing the charging process. It is proposed in this case that the actual location of the vehicle 10 on the grounds 4 is detected by the sensors 18 relative to the charging stations 6. On this basis, the computing unit 16 verifies whether or not this actual location fulfills a physical access requirement.

If the access requirement is fulfilled, the driver and any other passengers of the vehicle 10 can disembark from it. Furthermore, it is possible here for a first input field 24a on the display field of the terminal device 20 to be occupied with the function “approach charging station.” As soon as the driver operates and/or activates this first input field 24a, the vehicle 10 moves from the actual location in the direction of a selected charging station 6 and is arranged in a charging position. For this, it is proposed that the vehicle 10 is navigated by the computing unit 16 of the charging park and/or its own computing unit to a charging position of the prescribed charging position and arranged in a prescribed physical charging orientation relative to the charging station 6.

If, however, upon checking the actual location in consideration of the access requirement by the computing unit 16 it is revealed alternatively that this access requirement is not fulfilled, the output module of the terminal device 20 of the driver is activated and the driver is told to move the vehicle 10 from the actual location to a nominal location, there being provided for this nominal location a nominal position on the grounds 4 and a nominal orientation of the vehicle 10 relative to the charging station 6. In the embodiment of the method shown here, it is proposed that, as shown by FIG. 1, the charging interface 12 of the vehicle 10 is facing away from the charging station 6. In this case, it is proposed that the driver be asked, for the nominal location, to at least turn the vehicle 10 around and/or turn it and arrange it in a nominal orientation in which the charging interface 12 of the vehicle 10 is facing the charging station 6 or its charging interface 8. After the vehicle 10 has been moved by the driver, taking into consideration the nominal location, a check is done to see whether or not the new resulting actual location fulfills the access requirement. If this is not the case, the driver is asked once more to place the vehicle 10 in the nominal location. Once the vehicle 10 has been arranged by its driver in the prescribed nominal location and the new actual location fulfills the access requirement, it is automatically moved from the new actual location and arranged in the prescribed charging position relative to the charging station 6.

It is possible that the access requirement for the actual location of the vehicle 10 is not fulfilled if there are too many obstacles on the grounds 4 between the actual location and the charging position, preventing an autonomous and/or automatic moving of the vehicle 10 to the charging position. In a further conceivable embodiment of the method, it is possible that at the time when the vehicle 10 has been arranged by the driver in the actual location all the charging stations 6 on the grounds 4 of the charging park are occupied by other vehicles. As soon as one of these charging stations 6 is free for the vehicle 10, a check will be made, taking into consideration a charging position for this now freed up charging station, to see whether or not the access requirement is fulfilled starting from the actual location of the vehicle 10. Furthermore, it is conceivable that the driver at first cannot use for his vehicle 10 the charging valet service or payment service. In this case, it is necessary for the driver to use the terminal device 20 to exchange the necessary information with the computing unit 16 in order to support the proposed charging valet services. Furthermore, it is possible for the driver to present through the output module of the terminal device 20 an authorization of the charging process and an option for payment of the charging process.

Once the vehicle 10 has reached the prescribed charging position and/or is arranged appropriately in this, it is possible to present to the driver, through the display field of the terminal device 20, instructions on connecting the charging interface 8 of the charging station 6 to the charging interface 12 of the vehicle 10 across a power transmission element configured as a charging cable, while the driver himself can organize a connection for the transfer of the electrical energy from the charging interface 8 of the charging station 6 to the charging interface 12 of the vehicle 10 in the charging cable. Alternatively it is also possible to organize a connection between the charging interfaces 8, 12 via a charging robot as a further component of the charging park and the system.

If the vehicle 10 has multiple charging interfaces 12 on its outer wall and the selected charging station 6 likewise has multiple charging interfaces 8, it is possible to connect a respective charging interface 12 of the vehicle 10 across a respective power transmission element to a respective charging interface 8 of the charging station 6 and to supply the drive battery of the vehicle with electrical energy from the charging station 6 synchronously through multiple power transmission elements.

Once the charging process is concluded, it is possible for the driver to remove the charging cable between the charging interfaces 8, 12, and a corresponding short message is likewise presented for this on the output module. Alternatively it is possible for the charging cable to be removed automatically by the charging robot.

Furthermore, it is possible for the driver to activate on the display field a second input field 24b, containing the function “exit charging station.” In this case, the vehicle 10 is automatically moved away from its charging position and then arranged in an actual location which allows the driver to once again enter the vehicle 10 and leave the grounds 4 of the charging park with the vehicle 10. However, if this is not possible, the driver will be asked to himself remove the vehicle from the charging position. This is conceivable, for example, when there are too many obstacles present on the path provided for the vehicle 10 to leave the grounds 4, preventing an automatic driving of the vehicle 10.

German patent application no. 10 2022 103472.0, filed Feb. 15, 2022, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for performing an electrical charging process for a vehicle in a charging park, the vehicle having at least one charging interface, while the charging park has at least one electrical charging station with at least one charging interface, the method comprising:
situating the vehicle in an actual physical location on the grounds of the charging park, and
checking to see whether the actual physical location does or does not fulfill a physical access requirement to the at least one charging interface of the at least one charging station, and
in the event that the access requirement is not fulfilled, asking the driver to place the vehicle in a nominal physical location, and
in the event that the physical access requirement is fulfilled, automatically moving the vehicle from the actual physical location to a selected charging station among the at least one charging station and automatically arranging the vehicle in a charging position.

2. The method according to claim 1, in which in the event that the vehicle is situated in the charging position the at least one charging interface of the vehicle is connected to the at least one charging interface of the selected charging station and the charging process is carried out.

3. The method according to claim 1, in which in the event that the vehicle needs to be arranged in the at least one nominal position based on a demand, the vehicle is moved by the driver from a current actual physical location to a new updated actual physical location, and for the resulting updated actual physical location of the vehicle a check is done to see whether or not it fulfills the physical access requirement.

4. The method according to claim 1, in which the actual physical location of the vehicle is dependent on an actual physical location of the vehicle on the grounds of the charging park and a current actual physical orientation of the vehicle within the grounds of the charging park and/or in which for the at least one nominal physical location of the vehicle there is provided at least one nominal physical position of the vehicle on the grounds of the charging park and at least one nominal physical orientation of the vehicle within the grounds of the charging park.

5. The method according to claim 1, in which the at least one charging interface of the vehicle is situated in at least one interface position on an outer wall of the vehicle, the respective actual physical location of the vehicle being dependent on the at least one interface position of the at least one charging interface of the vehicle, and/or the at least one nominal physical location of the vehicle being dependent on the at least one interface position of the at least one charging interface of the vehicle and/or at least one interface position of the at least one charging interface of the at least one charging station.

6. The method according to claim 1, in which the at least one nominal location and/or the charging position is provided depending on a power transmission element, wherein the at least one charging interface of the vehicle and the at least one charging interface of the selected charging station are connected to the at least one power transmission element.

7. The method according to claim 1, in which the vehicle is situated at first in an original position outside the grounds of the charging park, and the performance of the charging process is initiated, the charging park being selected from among at least one charging park, and the vehicle is navigated from the original position to the charging park, and the vehicle is placed in the actual location on the grounds of the charging park.

8. A system for performing an electrical charging process for a vehicle in a charging park, wherein the vehicle has at least one charging interface, while the charging park has at least one electrical charging station with at least one charging interface, wherein the vehicle is situated in an actual physical location on the grounds of the charging park, wherein the system comprises:
at least one sensor,
at least one computing unit, and
at least one output module,
wherein the at least one sensor is adapted to detect the actual physical location of the vehicle,
wherein the at least one computing unit is adapted to check and see whether the actual physical location does or does not fulfill a physical access requirement to the at least one charging interface of the at least one charging station, and
in the event that the access requirement is not fulfilled the at least one output module is adapted to ask the driver to place the vehicle in a nominal physical location among at least one nominal physical location, and
in the alternative event that the physical access requirement is fulfilled the at least one computing unit is adapted to control the vehicle and move it automatically from the actual physical location to a selected charging station among the at least one charging station and automatically arrange it in a charging position.

9. The system according to claim 8, comprising a communication system, which is adapted to exchange information between the vehicle, the output module, the at least one charging station and/or a computing unit of the charging park.
